(19) United States
(12) Patent Application Publication
(10) Pub. No.: US 2024/0177335 A1
(43) Pub. Date: May 30, 2024

(54) DATA PROCESSING METHOD, ELECTRONIC APPARATUS, AND STORAGE MEDIUM

(71) Applicant: Lenovo (Beijing) Limited, Beijing (CN)

(72) Inventor: Liang LI, Beijing (CN)

(21) Appl. No.: 18/492,013

(22) Filed: Oct. 23, 2023

(30) Foreign Application Priority Data
Nov. 29, 2022 (CN) 202211510087.8

(51) Int. Cl. G06T 7/70; G06T 7/20; G06V 40/16; G06V 40/20; G10L 25/63; H04R 3/00

(52) U.S. Cl. CPC G06T 7/70; G06T 7/20; G06V 40/16; G06V 40/20; G10L 25/63; H04R 3/005; G06T 2207/10016; G06T 2207/30201

(57) ABSTRACT

Data processing method and device, electronic device and storage medium are provided. The data processing method includes acquiring behavioral attribute data of each object in a target space environment based on audio data and image data in the target space environment; determining target objects and output parameters thereof at least based on the behavioral attribute data; and controlling electronic devices in the target space environment to output target image data and/or target audio data of the target objects according to the output parameters.

### CROSS-REFERENCE TO RELATED APPLICATION

This application claims priority of Chinese Patent Application No. 202211510087.8, filed on Nov. 29, 2022, the entire contents of which are hereby incorporated by reference.

### FIELD OF THE DISCLOSURE

The present disclosure generally relates to the field of data processing technology and, more particularly, relates to a data processing method and device, electronic apparatus, and storage medium.

### BACKGROUND

In some video scenarios, a video output content often requires the speaker to be highlighted. For example, when someone speaks, a video image may be cropped or enlarged to highlight the speaker. When a group of people takes turns speaking or discussing, video screens may frequently jump from one to another, which affects user experience on watching the video.

### BRIEF SUMMARY OF THE DISCLOSURE

One aspect of the present disclosure provides a data processing method. The data processing method includes acquiring behavioral attribute data of each object in a target space environment based on audio data and image data in the target space environment; determining target objects and output parameters thereof at least based on the behavioral attribute data; and controlling electronic devices in the target space environment to output target image data and/or target audio data of the target objects according to the output parameters.

Another aspect of the present disclosure provides a data processing device. The data processing device includes an attribute acquisition module, for acquiring behavioral attribute data of each object in a target space environment based on audio data and image data in the target space environment; a determination module, for determining target objects and output parameters thereof based on at least the behavioral attribute data; and a control module, for controlling electronic devices in the target space environment to output target image data and/or target audio data of the target objects according to the output parameters.

Another aspect of the present disclosure provides an electronic apparatus. The electronic apparatus includes one or more processors; and a memory coupled to the one or more processors and storing computer programs that, when being executed, cause the one or more processors to perform: acquiring behavioral attribute data of each object in a target space environment based on audio data and image data in the target space environment; determining target objects and output parameters thereof, at least based on the behavioral attribute data; and controlling electronic devices in the target space environment to output target image data and/or target audio data of the target objects according to the output parameters.

Another aspect of the present disclosure provides a non-transitory computer readable storage medium that contains computer programs that, when being executed, cause one or more processors to perform: acquiring behavioral attribute data of each object in a target space environment based on audio data and image data in the target space environment; determining target objects and output parameters thereof, at least based on the behavioral attribute data; and controlling electronic devices in the target space environment to output target image data and/or target audio data of the target objects according to the output parameters.

Other aspects of the present disclosure can be understood by a person skilled in the art in light of the description, the claims, and the drawings of the present disclosure.

### BRIEF DESCRIPTION OF THE DRAWINGS

To illustrate technical solutions in embodiments of the present disclosure more clearly, the following briefly introduces accompanying drawings that need to be used in a description of the embodiments. Obviously, the accompanying drawings in the following description are only some embodiments of the present disclosure. For a person skilled in the art, other drawings can also be acquired from the accompanying drawings without creative efforts.

FIG. 1 illustrates an implementation flow chart of a data processing method consistent with various embodiments of the present disclosure;

FIG. 2 illustrates an implementation flow chart for acquiring behavioral attribute data of each object in a target space environment based on audio data and image data in the target space environment consistent with various embodiments of the present disclosure;

FIG. 3 illustrates an implementation flow chart for determining behavioral attribute data of each vocal object based on a spatial position and a sound source location consistent with various embodiments of the present disclosure;

FIG. 4A illustrates an exemplary diagram for acquiring behavioral attribute data of each vocal object in a target space environment consistent with various embodiments of the present disclosure;

FIG. 4B illustrates an exemplary diagram of a panoramic image consistent with various embodiments of the present disclosure;

FIG. 5 illustrates an implementation flow chart for determining target objects and output parameters thereof based on at least behavioral attribute data of each object consistent with various embodiments of the present disclosure;

FIG. 6 illustrates a schematic diagram of a data processing device consistent with various embodiments of the present disclosure; and

FIG. 7 illustrates a schematic diagram of an electronic apparatus consistent with various embodiments of the present disclosure.

Terms “first”, “second”, “third”, “fourth” or the like (if present) in the description, claims and accompanying drawings are used to distinguish similar parts and are not necessarily used to describe a specific order or sequence. It should be understood that data so used are interchangeable under appropriate circumstances so that embodiments of the present disclosure described herein can be practiced in other sequences than those illustrated herein.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, but not all the embodiments. Based on the embodiments in the present disclosure, all other embodiments acquired by a person skilled in the art without creative efforts shall fall within the protection scope of the present disclosure.

A data processing method provided by the embodiments of the present disclosure can be performed by an electronic apparatus. The electronic apparatus can be a terminal device or a server device. The server device can be a single server or a server cluster.

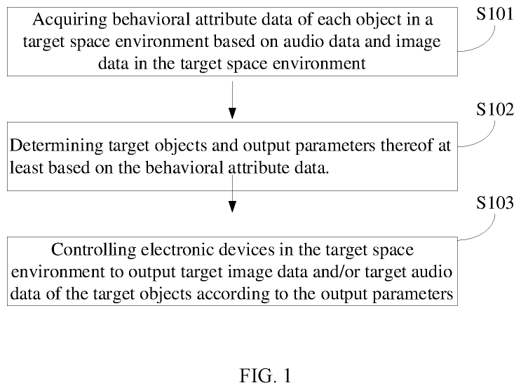

FIG. 1 illustrates an implementation flow chart of a data processing method consistent with various embodiments of the present disclosure. The implementation includes the following steps.

S101: acquiring behavioral attribute data of each object in a target space environment based on audio data and image data in the target space environment.

As an example, the target spatial environment may include a plurality of physical spaces participating in multi-party audio interactions. For example, if there are N (N is an integer greater than 1) parties conducting an audio conference, the target space environment may include N physical spaces where the N parties participating in the audio conference are located. Different parties are in different physical spaces. Each party has one or more participants.

As an example, the target spatial environment may include a plurality of physical spaces participating in multi-party video interactions. For example, if there are N (N is an integer greater than 1) parties conducting a video conference, the target space environment may include N physical spaces where the N parties participating in the video conference are located. Different parties are in different physical spaces. Each party has one or more participants.

As an example, the target space environment may be a specific physical space where a live audio broadcast takes place. A plurality of people in the specific physical space participates in the live audio broadcast.

As an example, the target space environment may be a specific physical space where live video broadcast takes place. A plurality of people in the specific physical space participates in the live video broadcast.

The behavioral attribute data of an object may be statistical characteristics of the object's behavior. For example, the statistical characteristics of the object's behavior may include but are not limited to at least one of the following: speaking duration, stopping speaking duration, number of speeches, average volume, movement range, action correlation, and the like.

S102: determining target objects and output parameters thereof at least based on the behavioral attribute data.

Optionally, the target objects and the output parameters thereof can be determined based on only the behavioral attribute data of each object.

Optionally, the target objects and the output parameters thereof can be determined based on the behavioral attribute data and other data of each object. Other data may include but is not limited to environmental information within the target space environment.

The output parameters of the target objects may at least include display parameters of the target objects, and/or audio playback parameters of the target objects. The display parameters of the target objects may specifically include a display layout and a display mode of the target objects and the like. The audio output parameters of the target objects may include but are not limited to audio signal-to-noise ratio, volume, and the like.

S103: controlling electronic devices in the target space environment to output target image data and/or target audio data of the target objects according to the output parameters.

Electronic devices in different physical spaces in the target space environment communicate over a network.

The target image data of the target objects may be image data of the target objects collected in real time, or may be cropped from the image data of the target objects collected in real time, or may be pre-stored image data (e.g., system avatar data, which can be a default image provided by the system, specified by the target objects or the like), or may be image data specified by the target objects, or may be virtual objects of the target objects generated based on the image data of the target objects collected in real time. In a scenario of audio conference or live audio broadcast, the target image data of the target objects can be system avatar data, or specified image data. In a scenario of video conferencing and live video broadcast, the target image data of the target objects can be images of the target objects collected in real time, or virtual objects of the target objects generated based on the images of the target objects collected in real time.

The target audio data of the target objects may be the audio data of the target objects collected in real time, or audio data acquired by optimizing the audio data of the target objects collected in real time (e.g., noise reduction, invalid voice muting and the like).

The data processing method provided by the present disclosure determines the target objects and output parameters thereof based on the behavioral attribute data of each object in the target space environment and controls each electronic device in the target space environment to output the target image data and/or the target audio data of the target objects according to the output parameters. Since behavioral attribute data of objects has statistical characteristics, the present disclosure can avoid outputting image data and/or audio data of vocal objects whenever objects in the target space environment produce sounds, thereby avoiding frequent jumps in outputting images and/or audios.

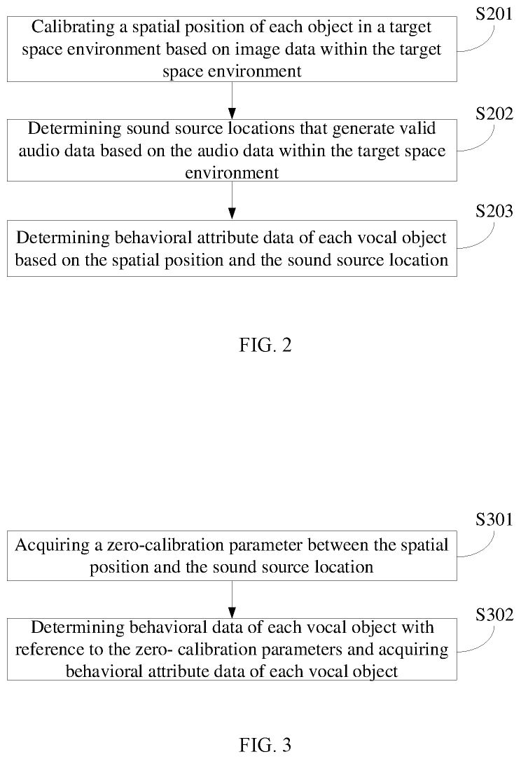

FIG. 2 illustrates an implementation flow chart for acquiring behavioral attribute data of each object in a target space environment based on audio data and image data in the target space environment consistent with various embodiments of the present disclosure. In one optional embodiment, the implementation includes the following steps.

S201: calibrating a spatial position of each object in a target space environment based on image data within the target space environment.

As an example, the image data within the target space environment includes panoramic images of all the physical spaces within the target space environment, that is, panoramic images are collected for all the physical spaces. For a panoramic image of a first physical space (the first physical space is any physical space within the target space environment), a position of each object in the first physical space can be determined in the panoramic image of the first physical space through face detection and/or humanoid detection. That is, the position of each object in the first physical space in the panoramic image of the first physical space is determined through face detection and/or humanoid detection. That is, the present disclosure uses face detection and/or humanoid detection to calibrate each object in the first physical space in the panoramic image of the first physical space.

A face detection result represents whether faces exist in the panoramic image in the first physical space, and position of the faces in the panoramic image when faces exist, which are generally calibrated by a rectangular frame. A humanoid detection result represents whether human bodies exist in the panoramic image in the first physical space, and positions of the human bodies in the panoramic image when human bodies exist, which is generally calibrated by a rectangular frame.

Optionally, a face detection can be first performed on image data of the first physical space (i.e., a panoramic image). If human faces are not detected, a humanoid detection is performed on image data in the first physical space. If human faces are detected, there is no need to perform a humanoid detection on the image data in the first physical space.

Optionally, human body detection can be first performed on the image data of the first physical space, and face detection can be performed on detected human body areas. If no faces are detected, a human body detection result is directly used as a calibration result. If faces are detected, a face detection result is used as the calibration result.

S202: determining sound source locations that generate valid audio data based on the audio data within the target space environment.

As an example, the audio data in the target space environment includes omnidirectional audio data of each physical space in the target space environment, that is, 360-degree sound pickup is performed for each physical space to acquire the omnidirectional audio data. For the omni-directional audio data of the first physical space (the first physical space is any physical space within the target space environment), sound source positioning and human voice detections can be performed based on the omni-directional audio data of the first physical space. If a human voice detection result indicates a presence of human voices, a sound source positioning result is determined to be sound source locations that generate valid audio data. Conversely, if no human voices are detected, the sound source positioning result is determined not to be the sound source locations that generate valid audio data. Through a human voice detection, non-human voice noises (i.e., the sounds when there is no human voice) in the environment can be filtered out, such as sounds of hitting a table, clapping, objects falling, and the like.

A sound source location represents an orientation of a sound source relative to the audio collection device, which is usually an angle value.

It should be noted that the present disclosure does not limit an execution order of S201 and S202. S201 may be executed first and then S202, or S202 may be executed first and then step S201, or step S201 and step S202 may be executed at a same time.

Optionally, the present disclosure can also perform a voiceprint recognition based on valid audio data in the target space environment to determine identities of vocal objects.

S203: determining behavioral attribute data of each vocal object based on the spatial position and the sound source location.

Based on spatial positions of all objects and locations of sound sources that produce valid audio data within a same physical space, which objects are voicing in the same physical space can be determined, and behavioral attribute data of vocal objects in the same physical space can be statistically acquired.

After acquiring the behavioral attribute data of each vocal object in each physical space, the behavioral attribute data of each vocal object in the target space environment is also acquired.

FIG. 3 illustrates an implementation flow chart for determining behavioral attribute data of each vocal object based on a spatial position and a sound source location consistent with various embodiments of the present disclosure. Optionally, in one embodiment, the implementation includes the following steps.

S301: acquiring a zero-calibration parameter between the spatial position and the sound source location.

The sound source location acquired by the sound source positioning is an integer value in the range of 0-359. Each value represents an angle, indicating that a presence of vocal objects within a small angle range to the left and right of the angle. The small angular range depends on an accuracy of an algorithm. For example, each numerical value indicates a presence of vocal objects within a range of 7.5 degrees to the left and right of the angle represented by the numerical value. Position of all objects in the first physical space in the panoramic image of the first physical space are usually distributed along a straight line. Therefore, the panoramic image of the first physical space can be evenly divided into 360 subregions along a target straight line direction (i.e., a distribution direction of all the objects in the panoramic image). Each subregion uniquely corresponds to a unit angle range. A specific corresponding relationship can be determined through a predetermined zero-calibration parameter corresponding to the first physical space.

Optionally, the zero-calibration parameter corresponding to the first physical space is a difference parameter, which represents a difference between a position of a certain vocal object in the first physical space determined through sound source positioning and a position of the certain vocal object in the panoramic image of the first physical space determined through image recognition. The zero-calibration parameter corresponding to the first physical space synchronously associates the sound source data and the image data in the first physical space.

Specifically, the zero-calibration parameter corresponding to the first physical space represents a matching difference (denoted as a datum difference) between a certain subregion of the panoramic image of the first physical space (denoted as a datum subregion) and a certain unit angle range (denoted as a datum unit angle range). The matching difference between the datum subregion and the datum unit angle range can be a difference between a first ranking of the datum subregion among all subregions (i.e., 360 subregions) of the panoramic image in the first physical space and a second ranking of the datum unit angle range among all unit angle ranges (i.e., 360 unit angle ranges). The 360 subregions can be sorted from small to large according to coordinates in the target straight line direction or can also be sorted from large to small according to coordinates in the target straight line direction. The 360 unit angle range can be sorted from small to large angle values or sorted from large to small angle values.

Specifically, the zero-calibration parameter corresponding to the first physical space can be determined by determining a first spatial position of a first vocal object at a first sound source location in the first physical space in a target space environment image. The target space environment image is a panoramic image of the first physical space. The first vocal object may be any vocal object in the first physical space. The first sound source location may be a position of the first vocal object in the first physical space.

The audio data and the image data in the first physical space can be collected when the first vocal object is voicing, a sound source location (denoted as the first sound source location) is determined based on the collected audio data. The spatial position of the first vocal object is calibrated based on the collected image data, and a calibration result is denoted as the first spatial position.

A matching difference between the first spatial position and the first sound source location is determined, and the matching difference is determined as the zero-calibration parameter corresponding to the first physical space. As an example, the first spatial position can be represented by a subregion (i.e., the datum subregion) where a center point of a marked frame (generally a rectangular frame) of the first vocal object is located. The matching difference (denoted as the datum difference) between the first spatial position and the first sound source location can be a difference between a first ranking of a subregion where a center point of a mark box of the first vocal object is located among all subregions (i.e., 360 subregions), and a second ranking of a unit angle range to which the first sound source location belongs (i.e., the base unit angle range) among all unit angle ranges (i.e., the 360 unit angle range).

The unit angle range to which the first sound source location belongs refers to a unit angle range with the first sound source location as a starting angle. For example, if the first sound source location is 0°, the unit angle range to which the first sound source location belongs refers to the unit angle range from 0° to 1° excluding 1°. That is, the unit angle range to which the first sound source location belongs is [0°,1°).

S302: determining behavioral data of each vocal object with reference to the zero-calibration parameters and acquiring behavioral attribute data of each vocal object.

Once the zero-calibration parameter corresponding to the first physical space has been determined, for any spatial position in the panoramic image of the first physical space, referring to the zero-calibration parameter corresponding to the first physical space, based on a matching difference between any spatial position and a sound source location that generates valid audio data, whether an object at any spatial position is within a range represented by a sound source positioning result is determined.

Specifically, if the matching difference between any spatial position and the sound source location that generates valid audio data is the datum difference, it can be determined that an object at any spatial position in the panoramic image of the first physical space is within a range represented by the sound source positioning result. Otherwise, if the matching difference between any spatial position and the sound source location that generates valid audio data is not the reference difference, it can be determined that the object at any spatial position in the panoramic image of the first physical space is not within the range represented by the sound source positioning result.

The matching difference between any spatial position and the sound source location that generates valid audio data can be a difference between a third ranking of a subregion where a center point of any spatial position is located among all subregions of the panoramic image of the first physical space and a fourth ranking of a unit angle range to which the sound source location that generates valid audio data belongs among all unit angle ranges.

Once objects within a range represented by the sound source location that generates valid audio data are determined, whether each object is a vocal object can be determined.

If a first object (any object in the first physical space) is within the range represented by the sound source location that generates valid audio data (e.g., 7.5 degrees to the left and right of the sound source location that generates valid audio data), the first object may be a vocal object. If the first object is not within the range represented by the sound source location that generates valid audio data, the first object can be determined not to be a vocal object.

If there is only the first object within the range represented by the sound source location that generates valid audio data, the first object is determined to be a vocal object. If there is not only the first object within the range represented by the sound source location that generates valid audio data, the first object is determined not to be a vocal object. That is, when there is only one object within the range represented by the sound source location that generates valid audio data, the one object is determined to be a vocal object.

When there are at least two objects within the range represented by the sound source location that generates valid audio data, a lip movement detection can be performed on the image data at a spatial position of each object within the range represented by the sound source location that generates valid audio data. If lip movements are detected in the image data at a spatial position of a second object (the second object is any object within the range represented by the sound source location that generates valid audio data), the second object is determined to be a vocal object. If lip movements are not detected in the image data at the spatial position of the second object, the second object is determined not to be a vocal object.

In some cases, for example, when a mask is worn, lip movements cannot be detected, and a voiceprint recognition and a human face recognition can be combined to determine a vocal object. Specifically, the voiceprint recognition can be performed on valid audio data (i.e., data containing human voices) in the first physical space to determine identity information of the vocal object (denoted as first identity information), and the human face recognition can be performed on a face area detected in the image data in the first physical space (i.e., image data at a calibrated spatial position) to determine identity information corresponding to the face area (denoted as second identity information). If the second identity information corresponding to the first face area is same as the first identity information, it is determined that an object represented by the first face area is the vocal object; otherwise, it is determined that the object represented by the first face difference is not the vocal object.

Optionally, when lip movements cannot be detected, the vocal target can also be determined by combining voiceprint recognition and humanoid recognition. Specifically, voiceprint recognition can be performed on the valid audio data in the first physical space to determine the identity information of the vocal object (denoted as the first identity information). Human body recognition is performed on the human body area detected in the image data of the first physical space (i.e., image data at a calibrated spatial position) to determine identity information corresponding to a human body area (denoted as third identity information). If the third identity information corresponding to a first human body region is same as the first identity information, the object represented by the first human body region is determined to be a vocal object. Otherwise, if the third identity information corresponding to a first human body region is different from the first identity information, the object represented by the first human body region is determined not to be a vocal object.

Optionally, when a lip movement cannot be detected, if an object in the target space environment is close enough to a camera to have a face clearly photographed but not a whole body, the object is subject to results of a face detection and a human face recognition. If an object in the target space environment is far away from the camera and has a whole body clearly photographed but not a face, the object is subject to results of a humanoid detection and a human body recognition.

Once a vocal object is determined in the first physical space, an identity of the vocal object can be determined using image data at a spatial position of the vocal object in the first physical space, so that behavior data of the vocal object can be subsequently recorded. For example, if the image data at the spatial position of the vocal object in the first physical space is image data of a face area, an identity of the vocal object can be determined through human face recognition. If the image data at the spatial position of the vocal object in the first physical space is image data of the human body area, the identity of the vocal object can be determined through human body recognition.

Optionally, the valid audio data in the first physical space can also be used to determine identity information of vocal objects in the first physical space. Once the vocal objects are determined, behavior data of each vocal object can be recorded to statistically acquire behavioral attribute data of each vocal object. The behavior data of a vocal object may include but is not limited to start sound time and end sound time, a location of the vocal object, a shape of the vocal object and the like.

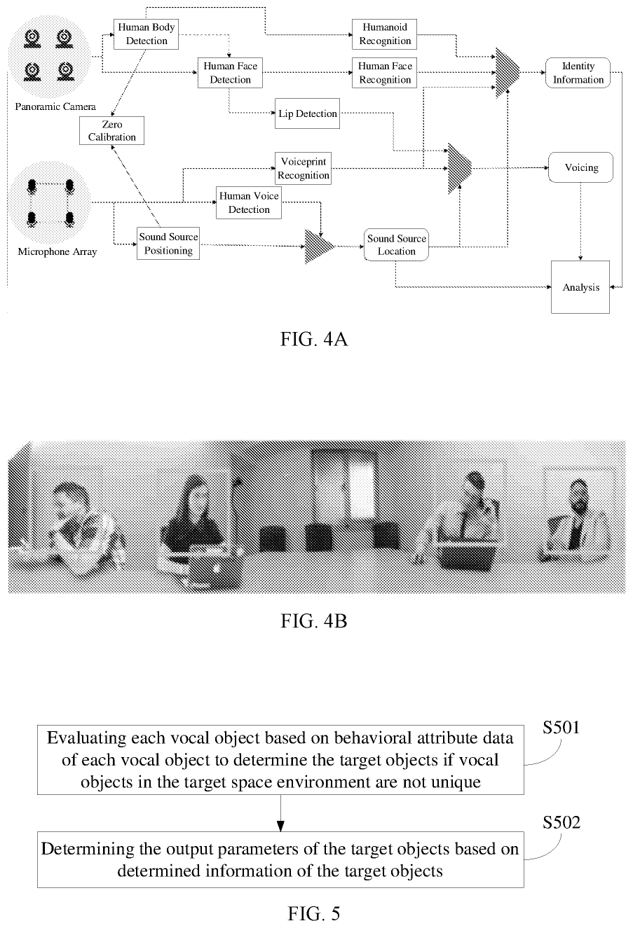

FIG. 4A illustrates an exemplary diagram for acquiring behavioral attribute data of each vocal object in a target space environment consistent with various embodiments of the present disclosure. A panoramic camera (i.e., 360-degree camera) and a microphone array are arranged in the first physical space, and a panoramic image in the first physical space is collected through a panoramic camera. FIG. 4B illustrates an exemplary diagram of a panoramic image consistent with various embodiments of the present disclosure. In one embodiment, there are four objects in the first physical space laterally distributed in the panoramic image. Audio data within a 360-degree range in the first physical space is collected through the microphone array.

Sounds can be produced by any object (denoted as a first vocal object) at any position in the first physical space (denoted as a first sound source location). At a same time, an panoramic image of the first vocal object is collected through the panoramic camera, and audio data of the first vocal object is collected through the microphone array.

A sound source location (i.e., the first sound source location) is determined based on the collected audio data, and a spatial position of the first vocal object is calibrated according to the collected image data, and the calibration result is the first spatial position.

A matching difference between the first spatial position and the first sound source location is determined, and the matching difference is determined as the zero-calibration parameter corresponding to the first physical space. In FIG. 4A, the zero position is calibrated based on humanoid detection and sound source localization results. In other embodiments, zero calibration can also be performed based on face detection and sound source localization results.

The panoramic camera and the microphone array continue to collect image data and audio data from the first physical space at a same time.

A humanoid detection and/or a face detection are performed on collected image data to calibrate a spatial position of each object in the first physical space. The face detection can be performed directly on the image data, or the humanoid detection can be first performed on the image data, and then the face detection can be performed on a detected human body area. As shown in FIG. 4B, a rectangular box is a calibration result acquired by the humanoid detection on the collected image data.

Based on a human body detection result (i.e., a calibrated human body area) for human body recognition, identity information corresponding to the human body area can be acquired. The human face recognition is performed based on a face detection result (i.e., a calibrated face area), and identity information corresponding to the face area can be acquired. By performing a lip movement detection based on the face detection results, a lip movement detection result can be acquired. A sound source localization, a voiceprint recognition and a human voice detection are performed on the collected audio data. If the human voice detection result is that a human voice is detected, a sound source location may be determined to be the sound source location that generates valid audio data; otherwise, the sound source location may be determined to be the sound source location that generates invalid audio data.

Based on the above information, the following analysis can be carried out.

Based on the spatial position of each object acquired by calibration, the sound source location acquired by sound source positioning, and the zero-calibration parameter, it can be determined whether an object at each spatial position is within the range represented by the sound source location of the valid audio data.

For each object within the range represented by the sound source location of the valid audio data (referred to as a within-range object), identity information of objects in each range can be determined based on the human body recognition result or the human face recognition result of the objects in each range in the first physical space. Identity information of vocal objects in the first physical space can be determined according to the voiceprint recognition result, and which objects in the image data are voicing can be determined according to the lip movement detection result.

When only one object exists within the range represented by the sound source location of the valid audio data, the only one object is the vocal object.

When at least two objects exist within the range represented by the sound source location of the valid audio data, if the lip movement detection result indicates that lip movements are detected on objects within the range, vocal objects within the range represented by the sound source location of the valid audio data can be directly determined in the image data. If the lip movement detection result indicates that no lip movement is detected on objects within the range, the human body recognition result or the human face recognition result and the voiceprint recognition result can be combined to determine the vocal object.

Once vocal objects are determined, behavioral data of each vocal object can be recorded, and behavioral data of each vocal object can be statistically analyzed to determine behavioral attribute data of each vocal object. Behaviors of a vocal object may include vocal behaviors and/or movement behaviors. The vocal behaviors can include speaking start time and speaking end time of the vocal object. The movement behaviors may include a location and a shape of the vocal object. Based on the speaking start time and end time of the vocal object, speaking duration, number of speeches, duration of stopping talking, average volume and the like of the vocal object can be counted. A movement range of the vocal object can be determined based on the location of the vocal object. An action of the vocal object can be determined based on the shape of the vocal object.

In one optional embodiment, if it is determined that a unique vocal object (or only one vocal object) exists in the target space environment, the unique vocal object can be determined as a target object, and second output parameters can be determined as the output parameters of the target object. That is, when it is determined that the vocal object is always a same object based on the calibrated spatial position and the sound source location that generates valid audio data (such as in a meeting report scene), specified output parameters (i.e., the second output parameters) are used as the output parameters of the target object.

A visual cue effect of target objects under the second output parameters is stronger than a visual cue effect of other objects in a target space environment.

The second output parameters may include display layout parameters and/or a display mode parameter. Controlling electronic devices in the target space environment to output target image data of the target objects according to the second output parameters may include controlling the electronic devices in the target space environment to output the target image data of the target objects according to the display layout parameter and/or the display mode parameter in the second output parameters.

As an example, a display layout may include displaying only the target image data of the target objects. The corresponding display mode may include full screen display, or non-full screen display.

As an example, the display layout may include displaying both the target objects and non-target objects. A corresponding display method may include highlighting the target objects. If the target image data is determined based on a real-time collected image, real-time collected image data of each object can be cropped to acquire target image data of each object. The target image data of each object is spliced, and a spliced image is displayed through the electronic devices in the target space environment. When the spliced image is displayed, the target objects are highlighted by, for instance, adding a highlighted rectangular frame around the target image data of the target objects and the like. Optionally, a size of target image data of the target objects can be different from a size of target image data of the non-target objects. For example, the target image data of the target objects is larger than the target image data of the non-target objects. In an image acquired by splicing, the target image data of each target object occupies a larger area, while the target image data of each non-target object occupies a smaller area, so that a visual cue effect of the target objects is stronger than a visual cue effect of the non-target objects in the target space environment.

The second output parameters may include a noise reduction parameter and/or an invalid speech muting parameter of the target audio data of the target objects. The target audio data is determined based on the audio data of the target object collected in real time. The audio data collected in real time can be divided into a plurality of speech frames, and each speech frame can be separately denoised and/or muted with invalid speech. The noise-reduced and/or muted speech frames are spliced to acquire the target speech data, and the target audio data is output. An invalid speech can be a sound that does not carry text content, such as a cough or the like.

In one optional embodiment, the audio data of the target objects collected in real time can also be output as the target audio data of the target object.

In one optional embodiment, an implementation of determining the target objects and output parameters thereof based on at least behavioral attribute data involves the following steps: determining a vocal object as the target object if it is determined, based on the behavioral attribute data, that the vocal object in the target space environment is unique; and determining the target object to have first output parameters based on the behavioral attribute data of the vocal object.

A visual cue effect of the target objects under the first output parameters is stronger than a visual cue effect of other objects in the target space environment. That is, for any object in the target space environment, based on the behavioral attribute data of the any object, it can be determined whether the object is a vocal object in the target space environment. For example, the behavioral attribute data may include speaking duration and/or number of speeches. If the speaking duration or the number of speeches of any object is zero, it can be determined that the object has not spoken. If the speech duration or the number of speeches of any object is not zero, it can be determined that the object has spoken. Therefore, if there is only one object in the target space environment whose speaking duration or number of speeches is not zero, and the speaking duration or number of speeches of other objects are all zero, it can be determined that the vocal object in the target space environment is unique. Otherwise, if there is not only one object in the target space environment whose speaking duration or number of speeches is not zero, or the speaking duration or number of speeches of other objects are not all zero, it is determined that the vocal object in the target space environment is not unique.

When it is determined that a vocal object in the target space environment is the only vocal object based on the behavioral attribute data, the only vocal object is determined as the target object. Based on the behavioral attribute data of the vocal object, the output parameters of the target object are determined as the first output parameters.

The first output parameters may include a display layout parameter and/or a display mode parameter. Controlling electronic devices in the target space environment to output the target image data of the target objects according to the first output parameters may include controlling the electronic devices in the target space environment to output the target image data of the target objects according to the display layout parameter and/or the display mode parameter in the first output parameters.

As an example, the display layout may include displaying only the target image data of the target object. A corresponding display mode may include full screen display, or non-full screen display.

As an example, the display layout may include displaying both the target objects and the non-target objects. A corresponding display method may include highlighting the target objects. If the target image data is determined based on a real-time collected image, real-time collected image data of each object can be cropped to acquire target image data of each object. The target image data of each object is spliced, and a spliced image is displayed through the electronic devices in the target space environment. When the spliced image is displayed, the target objects are highlighted by, for instance, adding a highlighted rectangular frame around the target image data of the target objects and the like. Optionally, a size of the target image data of the target objects can be different from a size of the target image data of the non-target objects. For example, the target image data of the target objects is larger than the target image data of the non-target objects. In an image acquired by splicing, the target image data of each target object occupies a larger area, while the target image data of each non-target object occupies a smaller area, so that a visual cue effect of the target objects is stronger than a visual cue effect of the non-target objects in the target space environment.

The first output parameters may include a noise reduction parameter and/or an invalid speech muting parameter of the target audio data of the target objects. The target audio data is determined based on the audio data of the target objects collected in real time. The audio data collected in real time can be divided into a plurality of speech frames, and each speech frame can be separately denoised and/or muted with invalid speech. The noise-reduced and/or the muted speech frames are spliced to acquire target speech data, and the target audio data is output. An invalid speech can be a sound that does not carry text content, such as a cough or the like.

In one optional embodiment, the audio data of the target object collected in real time can also be output as the target audio data of the target object.

FIG. 5 illustrates an implementation flow chart for determining target objects and output parameters thereof based on at least behavioral attribute data of each object consistent with various embodiments of the present disclosure. In one optional embodiment, the implementation may include the following steps.

S501: evaluating each vocal object based on behavioral attribute data of each vocal object to determine the target objects if vocal objects in the target space environment are not unique.

Whether a vocal object in the target space environment is the only one can be determined based on either the calibrated spatial position and the sound source location that generates valid audio data or the behavioral data of each object. Specific determination methods can be referenced in the above embodiments, which are not repeated herein.

When a vocal object in the target space environment is not unique, the target objects are filtered out based on the behavioral attribute data of each vocal object.

Optionally, the behavioral attribute data of a vocal object may include vocal parameters and/or motion parameters of the vocal object. The vocal parameters represent vocal attributes of the vocal object, which can include but are not limited to a speaking duration, a duration of stopping speaking, number of speeches, an average volume and the like. The motion parameters represent motion attributes of the vocal object, which may include but are not limited to a movement range, an action correlation and the like. Each vocal object can be evaluated to determine the target objects through at least one of the following two evaluation methods.

In a first evaluation method, based on the vocal parameters of a vocal object and the weight corresponding to the vocal parameters, the vocal behaviors of each vocal object are evaluated to acquire a comprehensive score and/or a specified item score, and a target object is determined based on at least one of the comprehensive score, the specified item score, and a historical evaluation information.

The first evaluation method does not involve the motion parameters of the vocal object, but only involves the vocal parameters of the vocal object. When the vocal parameters of the vocal object have a plurality of parameters, each vocal parameter has a corresponding weight. When vocal behaviors of a second vocal object which is any vocal object among all the vocal objects is evaluated, a single evaluation of the vocal behaviors of the second object can be performed based on each single vocal parameter of the second vocal object to acquire a single-item score of the second vocal object. The single-item scores of the second vocal object can also be combined to yield a comprehensive score.

The historical evaluation information of the second vocal object may include historical individual ratings and a historical comprehensive rating of the second vocal object. Specifically, a historical single-item score of the second vocal object may be an average of specified single-item scores of the second vocal object in previous audio/video recordings before a current audio/video recording, or a specified single-item score of the second vocal object in a most recent audio/video recording before a current audio/video recording. The historical comprehensive score of the second vocal object may be an average of the specified comprehensive scores of the second vocal object in previous audio/video recordings before the current audio/video recording, or a specified comprehensive score of the second vocal object in a most recent audio/video recording before a current audio/video recording.

Optionally, when the vocal parameters include a speaking duration, a single-item score corresponding to the speaking duration is positively correlated with the speaking duration. That is, the longer the speaking duration of the second vocal object, the higher the single-item score corresponding to the speaking duration of the second vocal object.

When the vocal parameters include an average volume, a single-item score corresponding to the average volume is positively related to the average volume. That is, the more times the second vocal object speaks, the higher the single-item score of the second vocal object corresponding to the number of speeches.

When the vocal parameters include a duration of stopping speaking, a single-item score corresponding to the duration of stopping speaking is negatively correlated with the duration of stopping speaking. That is, the longer the duration of stopping speaking of the second vocal object, the lower the single-item score of the second vocal object corresponding to the duration of stopping speaking. Optionally, the single-item score of the second vocal object corresponding to the duration of stopping speaking is a negative value, that is, the single-item score of the second vocal object corresponding to the duration of stopping speaking is less than zero.

If vocal behaviors of a vocal object are evaluated based on the comprehensive score, the single-item scores of the second vocal object can be weighted and summed to acquire the comprehensive score of the second vocal object.

As an example, the vocal parameters of the second object may include at least a speaking duration, number of speeches, and a duration of stopping speaking. When the vocal behaviors of the second vocal object are evaluated based on the comprehensive score, the comprehensive score of the vocal behaviors of the second vocal object is acquired by weighting and summing single-item scores corresponding to the speaking duration, number of speeches, and the duration of stopping speaking. A sum of a first weight corresponding to the single-item score corresponding to the speaking duration and a second weight corresponding to the single-item score corresponding to number of speeches is 1. Optionally, If the vocal behaviors of the vocal object are evaluated based on scoring specified items, the specified items can be the speaking duration or the number of speeches.

When the vocal behaviors of the second vocal object are evaluated based on at least two of the comprehensive score, the specified item score, and the historical comprehensive score, a final score of the second vocal object can be acquired by weighting and summing of at least two of the comprehensive score, the specified item score, and the historical comprehensive score. Based on the final score, whether the second vocal object is a target object is determined. For example, when the second vocal object is evaluated based on the comprehensive score and historical comprehensive score, a final score may be acquired by weighing and summing the comprehensive score of the second object and the historical comprehensive score. The target object may be determined based on the final score. Optionally, a weight corresponding to the comprehensive score is greater than or equal to a weight corresponding to the historical comprehensive score, and a sum of the weight corresponding to the comprehensive score and the weight corresponding to the historical comprehensive score is 1.

When the vocal behaviors of the second vocal object are evaluated based on any one of the comprehensive score, the specified item score, and the historical evaluation information, any of the above items can be used as the final score of the second vocal object, and the target object is determined based on the final score.

Once the final score of each vocal object is acquired, the vocal objects whose final score is greater than a scoring threshold can be determined as the target objects, or top N vocal objects in the final score ranking can be determined as the target objects. That is, the final score of the target objects is greater than the final scores of the non-target objects.

In a second evaluation method, based on the motion parameters and the vocal parameters of the vocal objects, the vocal behaviors of each vocal object are evaluated to determine the target objects.

The motion parameters of a vocal object may include a movement range of the vocal object and/or an action correlation of the vocal object and the like. The action correlation of the vocal object refers to a correlation between an action of the vocal object and a target product (such as a writing board, an exhibit or the like). The action correlation of the vocal object can be determined by a distance between a body of the vocal object in motion and the target product. The closer the distance between the body of the vocal object in motion and the target object, the greater the action correlation of the vocal object. Otherwise, the farther the distance between the body of the vocal object in motion and the target object, the smaller the action correlation of the vocal object.

For the second vocal object, the vocal behaviors of the second vocal object can be evaluated based on the motion parameters and the vocal parameters of the second vocal object to acquire a first score corresponding to the motion parameters of the second vocal object and a second score corresponding to the vocal parameters of the second vocal object. The first score and the second score are weighted and summed to acquire the final score of the second vocal object, and based on the final score, whether the second vocal object is a target object is determined.

When a vocal object is evaluated based on the motion parameters thereof, a score when a movement range of the vocal object is within a target range is greater than a score when the movement range of the vocal object exceeds the target range. The greater the action correlation of the vocal object, the higher the score of the vocal object. The first score of the motion parameter corresponding to the vocal object can be acquired by weighting and summing a score corresponding to the movement range of the vocal object and a score corresponding to the action correlation of the vocal object.

A process of evaluating the vocal behaviors of the second vocal object based on the vocal parameters of the second vocal object can be referred to previous embodiments, which is not repeated herein.

When the vocal objects are evaluated through the above two evaluation methods, the target objects determined based on the two evaluation methods can be combined to acquire the final target object.

S502: determining the output parameters of the target objects based on determined information of the target objects.

Optionally, the output parameters of the target object can be determined using at least one of the following methods: determining the output parameters based on determined number of target objects; determining the output parameters based on a determined relative positional relationship of the target objects; and determining the output parameters based on a determined interactive relationship between the target objects.

The relative positional relationship of the target objects can be determined by whether the target objects are in a same physical space. Optionally, if two target objects appear in an image captured by a same image acquisition device, the two target objects are determined to be in a same physical space.

Interactions between the target objects can include whether a conversation exists between the target objects, whether a conversation is between two target objects or a plurality of target objects, and the like.

Optionally, when only one target object exists, an output parameter can be either displaying target image data of only the target object or displaying target image data the target object and non-target objects, in which a display area of the target image data of the target object is larger than a display area of the target image data of each non-target object. When only the target image data of the target object is displayed, the target image data of the target object may or may not be displayed in full screen.

When at least two target objects exist, an output parameters can be either displaying target image data of only the at least two target objects or displaying target image data of the at least target objects and at least part of the non-target objects (scores of the non-target objects with the target image data displayed are higher than scores of the non-target objects without target image data displayed), in which a display area of the target image data of each target object is larger than a display area of the target image data of each non-target object.

When at least two target objects exist, an output parameter can be either displaying target objects in a same physical space in a same image frame or displaying target objects in different physical spaces in different image frames. For example, if there are at least M (M is an integer greater than 1) target objects in a same physical space, the at least M target objects can be displayed in a same image frame.

When at least two target objects exist, if there are at least K (K is an integer greater than 1) target objects with similar scores among the at least two target objects, such that a difference in scores of any two target objects among the at least K target objects is less than or equal to a difference threshold, it is determined that the at least K target objects are in a conversation. If a difference in scores between any two of the at least two target objects is greater than the difference threshold, it is determined that the at least two target objects are not in a conversation.

If two target objects are in a conversation, an output parameter may be either displaying target image data of only the at least two target objects, or displaying target image data of the at least two target objects and at least part of the non-target objects, in which a display area of the target image data of each target object is larger than a display area of the target image data of each non-target object.

If a plurality of target objects is in a conversation (i.e., K is greater than 2), an output parameter can be displaying target image data of only the plurality of target objects.

In one optional embodiment, an implementation of determining the target object and output parameters thereof based on at least behavioral attribute data may be acquiring the motion parameters of each object in the target space environment base on the behavioral attribute data, determining objects that meets target motion conditions as the target objects, and determining the output parameters based on determined information about the target objects.

The motion parameters of an object may include but are not limited to a movement range, an action correlation, and the like. That is, when determining the target objects, the embodiment does not consider the vocal parameters of the target objects.

Meeting the target motion conditions may include but are not limited to having a movement range within a target range and/or an action correlation of an object greater than a correlation threshold.

A process of determining the output parameters based on determined information about the target objects can be referred to previous embodiments, which is not repeated herein.

In one optional embodiment, the data processing method may further include acquiring environmental change information within the target space environment and updating the target image data and/or the target audio data based on the environmental change information. The environmental change information may include but is not limited to changes in number of objects, changes in environmental brightness, changes in environmental noise and the like. For example, when number of objects in a target physical space where any target object is located (the target physical space is one of the physical spaces within the target space environment) is less than a first quantity threshold, an image display of each object in real-time collected image data is relatively clear. The target image data of each target object in the target physical space can be acquired from the image data collected in real time. When number of objects in the target physical space is greater than or equal to the first quantity threshold, an image of each object in the image data collected in real time may not be clearly displayed. Pre-stored image data of each target object in the target physical space (e.g., system avatar, designated image, and the like) can be used as the target image data. For another example, when ambient brightness of the target physical space is greater than a brightness threshold, the target image data of each target object in the target physical space can be acquired from image data collected in real time. When the ambient brightness of the target physical space is less than or equal to the brightness threshold, pre-stored image data of each target object in the target physical space (e.g., system avatar, designated image, or the like) can be used as the target image data. For another example, when a noise in the target physical space is relatively large (e.g., a signal-to-noise ratio of the target audio data is less than a signal-to-noise ratio threshold), the target audio data of the target object in the target physical space is denoised and output. When the noise in the target physical space is relatively small (e.g., the signal-to-noise ratio of the target audio data is greater than or equal to the signal-to-noise ratio threshold), the target audio data of the target object in the target physical space may not be denoised but directly output.

In the embodiment, the data processing method may or may not further include acquiring environmental change information within the target space environment and adjusting the output parameters of the target objects based on the environmental change information. The environmental change information may include but is not limited to changes in number of objects, changes in environmental brightness, changes in environmental noise and the like. For example, when number of objects in the target space environment is less than a second quantity threshold, the output parameters may include increasing a size of the target image data of each target object. When the number of objects in the target space environment is greater than or equal to the second quantity threshold, the output parameter may include reducing the size of the target image data of each target object. For another example, when ambient brightness of the target physical space is less than or equal to a brightness threshold, the output parameters may include increasing a size of the target image data of each target object. The target image data of the target objects may be extracted from the image data collected in real time. For another example, when a noise in the target physical space is relatively large, the output parameters can include noise reduction and muting invalid sounds in the real-time collected audio data from the target objects in the target physical space. When the noise in the target physical space is relatively small, the output parameters may include only muting invalid sounds in the real-time collected audio data from the target objects in the target physical space.

In one optional embodiment, the data processing method may also include adjusting a processing algorithm used to determine the target objects in real time based on the change information of the target objects.

The present disclosure monitors the changing information of the target objects in real time. Optionally, when the number of target objects is greater than a third quantity threshold, the processing algorithm used to determine the target objects can be adjusted to reduce number of target objects and avoid frequent switching of the target image data of the target objects.

For example, when the target objects are determined based on at least one of the comprehensive score, a specified item score, and the historical score of the vocal objects, the score threshold may be increased to reduce the number of target objects.

For another example, when objects that meets the target motion conditions are determined as the target objects based on the motion parameters of each object in the target space environment, the target motion conditions can be improved to reduce the number of target objects.

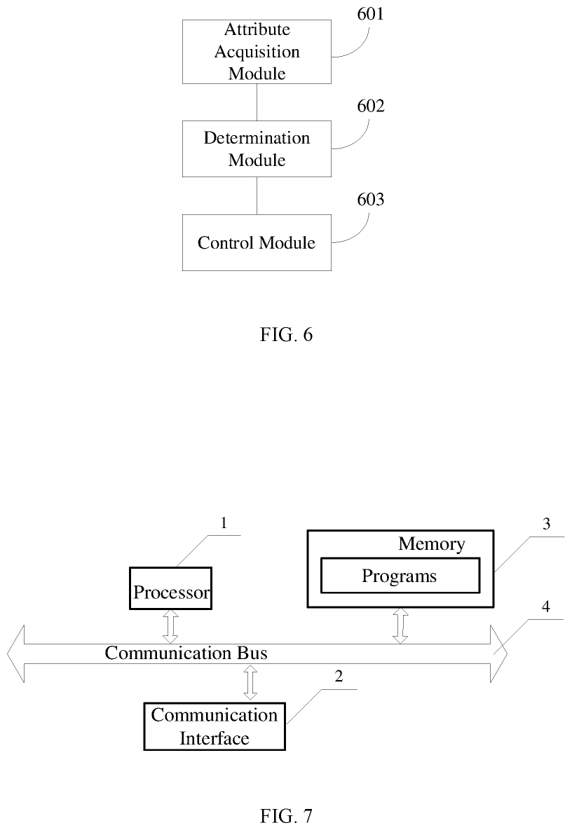

Corresponding to the method embodiments, the present disclosure also provides a data processing device. FIG. 6 illustrates a schematic diagram of a data processing device consistent with various embodiments of the present disclosure. In one embodiment, the data processing device includes an attribute acquisition module 601, a determination module 602 and a control module 603. The attribute acquisition module 601 is configured to acquire behavioral attribute data of each object in a target space environment based on audio data and image data in the target space environment. The determining module 602 is configured to determine target objects and output parameters thereof based on at least the behavioral attribute data. The control module 603 is configured to control electronic devices in the target space environment to output target image data and/or target audio data of the target objects according to the output parameters.

The data processing device provided by the embodiment determines the target objects and output parameters thereof based on the behavioral attribute data of each object in the target space environment. Each electronic device in the target space environment is controlled to output target image data and/or target audio data of the target objects according to the output parameters. Since the behavioral attribute data of an object exhibits statistical characteristics, the present disclosure can avoid outputting image data and/or audio data of vocal objects whenever the vocal objects in the target space environment produce sounds, thereby avoiding frequent jumps in outputting images and/or audios.

In one optional embodiment, the attribute acquiring module 601 is configured to calibrate the spatial position of each object in the target space environment based on the image data, determine the sound source locations that generate valid audio data based on the audio data, and determine the behavioral attribute data of each vocal object based on the spatial position and the sound source location.

In one optional embodiment, when the attribute acquisition module 601 determines the behavioral attribute data of each vocal object based on the spatial position and the sound source location, the attribute acquisition module 601 is configured to acquire a zero-calibration parameter between the spatial position and the sound source location, determine the behavior data of each vocal object with reference to the zero-calibration parameters, and acquire the behavioral attribute data of each vocal object.

In one optional embodiment, the data processing device further includes a zero-calibration parameter determination module for determining a first spatial position of a first vocal object at a first sound source location in the target space environment image, which is a panoramic image of the target space environment, determining a matching difference between the first spatial position and the first sound source location, and determining the matching difference as the zero-calibration parameter.

In one optional embodiment, the determining module 602 is configured to determine a vocal object as a target object if it is determined that the vocal object in the target space environment is the only vocal object based on the behavioral attribute data and determine that the target object has first output parameters based on the behavioral attribute data of the vocal object. A visual cue effect of the target object under the first output parameters is stronger than a visual cue effect of other objects in the target space environment.

In one optional embodiment, the determining module 602 is configured to evaluate each vocal object based on the behavioral attribute data to determine the target objects if it is determined that the vocal objects in the target space environment are not unique (e.g., more than one vocal objects are determined) and determine the output parameters based on determined information of the target objects.

In one optional embodiment, when the determination module 602 evaluates each vocal object to determine the target objects based on the behavioral attribute data, the determination module 602 performs at least one of the following tasks: evaluating the vocal behavior of each vocal object based on the vocal parameters of the vocal objects and weights corresponding to the vocal parameters, determining the target objects based on at least one of a comprehensive score, a specified item score, and historical evaluation information; and evaluating the vocal behaviors of each vocal object based on the motion parameters and vocal parameters of the vocal objects to determine the target objects.

Accordingly, the determination module 602 determines the output parameters based on determined information of the target object and performs at least one of the following tasks: determining the output parameters based on determined number of target objects; determining the output parameters based on a determined relative positional relationship between the target objects; and determining the output parameters based on a determined interactive relationship between target objects.

In one optional embodiment, the determination module 602 is configured to acquire motion parameters of each object in the target space environment based on the behavioral attribute data, determine objects that meets target motion conditions as the target object, and determine the output parameters based on determined information of the target objects.

In one optional embodiment, the control module 603 is configured to perform at least one of the following tasks: acquiring environment change information within the target space environment, updating the target image data and/or the target audio data based on the environment change information; acquiring environmental change information within the target space environment, adjusting the output parameters of the target objects based on the environmental change information; and adjusting a processing algorithm configured to determine the target objects in real time based on change information of the target objects.

Corresponding to the method embodiments, the present disclosure also provides an electronic apparatus. FIG. 7 illustrates a schematic diagram of an electronic apparatus consistent with various embodiments of the present disclosure. In one embodiment, the electronic apparatus includes at least one processor 1, at least one communication interface 2, at least one memory 3 and at least one communication bus 4.

In the embodiment, the at least one processor 1, the at least one communication interface 2, and at least one the memory 3 communicate with each other through the at least one communication bus 4.

Processor 1 may be a central processing unit (CPU), an application specific integrated circuit (ASIC), or one or more integrated circuits configured to implement the embodiments of the present disclosure.

Memory 3 may include high-speed RAM memory, non-volatile memory, and other components, including at least one disk memory.

Memory 3 stores programs, and processor 1 can call the programs stored in the memory 3. The programs are configured for acquiring behavioral attribute data of each object in a target space environment based on audio data and image data in the target space environment; determining target objects and output parameters thereof at least based on the behavioral attribute data; and controlling electronic devices in the target space environment to output target image data and/or target audio data of the target objects according to the output parameters.

Optionally, the detailed functions and extended functions of the programs can refer to the above description.

One embodiment also provides a storage medium that can store programs suitable for execution by a processor. The programs are configured for acquiring behavioral attribute data of each object in a target space environment based on audio data and image data in the target space environment; determining target objects and output parameters thereof at least based on the behavioral attribute data; and controlling electronic devices in the target space environment to output target image data and/or target audio data of the target objects according to the output parameters.

Optionally, the detailed functions and extended functions of the programs can refer to the above description.

A person skilled in the art may know that blocks and steps of the algorithm in the examples described with reference to the embodiments disclosed in this description of the invention can be implemented with electronic hardware or a combination of computer software and electronic hardware. Whether the functions are performed using hardware or software depends on specific applications and design limitations of technical solutions. One skilled in the art may use a different method to implement the described functions for each application, but it should not be considered that the implementation is outside the scope of the present disclosure.

In several embodiments presented herein, the disclosed system, device, and method may be implemented in other forms. In addition, the displayed or discussed mutual couplings or direct couplings or communication connections can be indirect couplings or communication connections through some interfaces, devices or units, and can be electronic, mechanical or other types.

Blocks described as separate parts may or may not be physically separate. Parts displayed as blocks may or may not be physical blocks and may be in a same location or distributed across a plurality of network blocks. Some or all the blocks may be selected depending on actual requirements to achieve the objectives of the solutions in the embodiments.

Moreover, functional blocks in the embodiments of the present disclosure can be combined into one processing unit, or each of the functional blocks can physically exist alone, or two or more blocks are combined into one block.

In the embodiments of the present disclosure, the rights, various embodiments, and features can be combined with each other to solve the above technical problem.

When implemented as a software function block and sold or used as an independent product, the functions may be stored on a computer-readable storage medium. Based on the above understanding, technical solutions of the present disclosure in general or in part that are part of the prior art, or some technical solutions can be implemented as a software product. A computer program product is stored on a storage medium and includes several instructions for instructing a computer device (which may be a personal computer, server, network device, or the like.) to perform all or some of the steps of the methods described in the embodiments of the present disclosure. The storage medium includes any medium that can store program code, for example, a USB flash drive, a removable hard disk, Read-Only Memory (ROM), random access memory (Random Access Memory, RAM), magnetic disk or optical disk.

As disclosed, the data processing method and device, electronic apparatus and storage medium provided by the present disclosure at least realize the following beneficial effects.

In the data processing method and device, electronic apparatus and storage medium, behavioral attribute data of each object in a target space environment is acquired based on audio data and image data in the target space environment. Target objects and output parameters thereof are determined at least based on the behavioral attribute data. Electronic devices in the target space environment are controlled to output target image data and/or target audio data of the target objects according to the output parameters. The present disclosure determines target objects and output parameters thereof based on behavioral attribute data of each object in the target space environment, and controls each electronic device in the target space environment to output target image data and/or target audio data of the target object according to the output parameters, thereby avoiding outputting image data and/or audio data of the vocal objects whenever objects in the target space environment produce sounds, thereby avoiding frequent jumps in outputting images and/or audios.

The above description of the disclosed embodiments enables a person skilled in the art to implement or use the present disclosure. Various modifications to these embodiments will be apparent to a person skilled in the art, and the general principles defined herein may be implemented in other embodiments without departing from the spirit or scope of the present disclosure. Therefore, the present disclosure is not limited to the embodiments shown herein but conforms to a widest scope consistent with the principles and novel features disclosed herein.

What is claimed is:

1. A data processing method, comprising:
acquiring behavioral attribute data of each object in a target space environment based on audio data and image data in the target space environment;
determining target objects and output parameters thereof, at least based on the behavioral attribute data; and
controlling electronic devices in the target space environment to output target image data and/or target audio data of the target objects according to the output parameters.

2. The method according to claim 1, wherein acquiring the behavioral attribute data of each object in the target space environment based on the audio data and the image data in the target space environment comprising:
calibrating a spatial position of each object in the target space environment based on the image data;
determining sound source locations that generate valid audio data based on the audio data; and
determining behavioral attribute data of each vocal object based on the spatial position and the sound source location.

3. The method according to claim 2, wherein determining the behavioral attribute data of each vocal object based on the spatial position and the sound source location comprising:
acquiring a zero-calibration parameter between the spatial position and the sound source location; and
determining behavior data of each vocal object with reference to the zero-calibration parameter and acquiring behavioral attribute data of each vocal object.

4. The method according to claim 3, wherein the zero-calibration parameter between the spatial position and the sound source location is determined by:
determining a first spatial position of a first vocal object at a first sound source location in a target space environment image, the target space environment image being a panoramic image of the target space environment; and
determining a matching difference between the first spatial position and the first sound source location and determining the matching difference as the zero-calibration parameter.

5. The method according to claim 1, wherein determining the target objects and the output parameters thereof at least based on the behavioral attribute data comprising:
determining a vocal object as the target object if it is determined that the vocal object in the target space environment is an only vocal object based on the behavioral attribute data, and determining that the target object has first output parameters based on behavioral attribute data of the vocal object, wherein:
a visual cue effect of the target object under the first output parameters is stronger than a visual cue effect of other objects in the target space environment.

6. The method according to claim 1, wherein determining the target objects and the output parameters thereof at least based on the behavioral attribute data comprising:
evaluating each vocal object based on the behavioral attribute data to determine the target objects if it is determined that vocal objects in the target space environment are not an only vocal object; and
determining the output parameters based on the determined information of the target objects.

7. The method according to claim 6, wherein:
evaluating each vocal object based on the behavioral attribute data to determine the target objects comprising at least one of following tasks:
evaluating vocal behaviors of each vocal object based on vocal parameters of the vocal objects and weights corresponding to the vocal parameters, and determining the target objects based on at least one of a comprehensive score, a specified item score, and historical evaluation information; and
determining accordingly the output parameters based on the determined information of the target objects includes at least one of the following tasks:
determining the output parameters based on determined number of target objects,
determining the output parameters based on a determined relative positional relationship between the target objects, and
determining the output parameters based on a determined interactive relationship between the target objects.

8. The method according to claim 1, wherein determining the target objects and the output parameters thereof at least based on the behavioral attribute data comprising:
acquiring motion parameters of each object in the target space environment based on the behavioral attribute data, determining objects that meet target motion conditions as the target objects, and determining the output parameters based on determined information of the target objects.

9. The method according to claim 1, further comprising at least one of following tasks:
acquiring environmental change information within the target space environment, updating the target image data and/or the target audio data based on the environmental change information;
acquiring environmental change information within the target space environment, and adjusting the output parameters of the target objects based on the environmental change information; and
adjusting a processing algorithm configured to determine the target objects in real-time based on change information of the target objects.

10. An electronic apparatus, comprising:
one or more processors; and
a memory coupled to the one or more processors and storing computer programs that, when being executed, cause the one or more processors to perform:
acquiring behavioral attribute data of each object in a target space environment based on audio data and image data in the target space environment;
determining target objects and output parameters thereof, at least based on the behavioral attribute data; and
controlling electronic devices in the target space environment to output target image data and/or target audio data of the target objects according to the output parameters.

11. The electronic apparatus according to claim 10, wherein the one or more processors are further configured to perform:
calibrating a spatial position of each object in the target space environment based on the image data;
determining sound source locations that generate valid audio data based on the audio data; and
determining behavioral attribute data of each vocal object based on the spatial position and the sound source location.

12. The electronic apparatus according to claim 11, wherein the one or more processors are further configured to perform:
acquiring a zero-calibration parameter between the spatial position and the sound source location; and
determining behavior data of each vocal object with reference to the zero-calibration parameter and acquiring behavioral attribute data of each vocal object.

13. The electronic apparatus according to claim 12, wherein the one or more processors are further configured to perform:
determining a first spatial position of a first vocal object at a first sound source location in a target space environment image, the target space environment image being a panoramic image of the target space environment; and
determining a matching difference between the first spatial position and the first sound source location and determining the matching difference as the zero-calibration parameter.

14. The electronic apparatus according to claim 10, wherein the one or more processors are further configured to perform:
determining a vocal object as the target object if it is determined that the vocal object in the target space environment is an only vocal object based on the behavioral attribute data, and determining that the target object has first output parameters based on behavioral attribute data of the vocal object, wherein:
a visual cue effect of the target object under the first output parameters is stronger than a visual cue effect of other objects in the target space environment.

15. The electronic apparatus according to claim 10, wherein the one or more processors are further configured to perform:
evaluating each vocal object based on the behavioral attribute data to determine the target objects if it is determined that vocal objects in the target space environment are not an only vocal object; and
determining the output parameters based on the determined information of the target objects.

16. The electronic apparatus according to claim 15, wherein the one or more processors are further configured to perform:
evaluating vocal behaviors of each vocal object based on vocal parameters of the vocal objects and weights corresponding to the vocal parameters, and determining the target objects based on at least one of a comprehensive score, a specified item score, and historical evaluation information;
determining the output parameters based on determined number of target objects,
determining the output parameters based on a determined relative positional relationship between the target objects, and
determining the output parameters based on a determined interactive relationship between the target objects.

17. The electronic apparatus according to claim 10, wherein the one or more processors are further configured to perform:
acquiring motion parameters of each object in the target space environment based on the behavioral attribute data, determining objects that meet target motion conditions as the target objects, and determining the output parameters based on determined information of the target objects.

18. The electronic apparatus according to claim 10, wherein the one or more processors are further configured to perform at least one of following tasks:
acquiring environmental change information within the target space environment, updating the target image data and/or the target audio data based on the environmental change information;
acquiring environmental change information within the target space environment, and adjusting the output parameters of the target objects based on the environmental change information; and
adjusting a processing algorithm configured to determine the target objects in real-time based on change information of the target objects.

19. A non-transitory computer readable storage medium containing computer programs that, when being executed, cause one or more processors to perform:
acquiring behavioral attribute data of each object in a target space environment based on audio data and image data in the target space environment;
determining target objects and output parameters thereof, at least based on the behavioral attribute data; and
controlling electronic devices in the target space environment to output target image data and/or target audio data of the target objects according to the output parameters.

20. The storage medium according to claim 19, wherein the one or more processors are further configured to perform:
calibrating a spatial position of each object in the target space environment based on the image data;
determining sound source locations that generate valid audio data based on the audio data; and
determining behavioral attribute data of each vocal object based on the spatial position and the sound source location.
